(19) United States
(12) Patent Application Publication
(10) Pub. No.: US 2009/0074352 A1
(43) Pub. Date: Mar. 19, 2009

(54) BIDIRECTIONAL OPTICAL TRANSMISSION DEVICE

(76) Inventors: Ikuo KOHASHI, Gojo-shi (JP); Hideya Takakura, Kitakatsuragi-gun (JP)

Correspondence Address: BIRCH STEWART KOLASCH & BIRCH, PO BOX 747, FALLS CHURCH, VA, 22040-0747, US

(21) Appl. No.: 12/207,268

(22) Filed: Sep. 9, 2008

(30) Foreign Application Priority Data
Sep. 13, 2007 (JP) 2007-237497

(51) Int. Cl. G02B 6/12

(52) U.S. Cl. 385/14

(57) ABSTRACT

In a bidirectional optical transmission device, a light-emitting element and a light-receiving element are mounted on one side of a base material and are sealed with an optically permeable resin section. The resin section includes a light emitting side resin section and a light receiving side resin section, and a slit is provided between these resin sections. The device further includes a light-blocking receptacle having a claw, and the claw of the receptacle is disposed in the slit between the light emitting side resin section and the light receiving side resin section. The claw of the receptacle prevents leakage of light from the light-emitting element between the light-emitting element and the light-receiving element.

This nonprovisional application claims priority under 35 U.S.C. §119(a) on Patent Application No. 2007-237497 filed in Japan on Sep. 13, 2007, the entire contents of which are hereby incorporated by reference.

### BACKGROUND OF THE INVENTION

The present invention relates to a bidirectional optical transmission device transmitting and receiving an optical signal using, for example, optical transmission mediums such as optical fibers, and in particular to a bidirectional optical transmission device aimed at being small, short, and surface-mounted required to be used for portable equipment.

Conventional optical signal transmission devices are not nearly so small as to be accommodated in small electronic equipment, and are generally configured as shown in FIGS. 11A and 11B. FIG. 11A shows an outline of a transmitting optical transmission device, and FIG. 11B shows an outline of a receiving optical transmission device.

As shown in FIG. 11A, the transmitting optical transmission device has a lead frame 101, a light-emitting element 102 mounted on the lead frame 101, a resin section 105 sealing the light-emitting element 102, and a case 109 covering the resin section 105.

The light-emitting element 102 is die-bonded in a predetermined island position of the lead frame 101 with conductive adhesive material such as Ag paste, and electrodes on the light-emitting element 102 are electrically connected to electrodes formed on the lead frame 101 by bonding with wires 106 such as Au wires.

The resin section 105 is made of, for example, optically permeable thermosetting epoxy resin and is molded by a transfer molding method or the like. A lens 105a is provided on one side of the resin section 105 to increase the efficiency of optical coupling with an optical fiber a. Furthermore, the case 109 is made of light-blocking resin or metallic material, and holds an optical fiber which has been inserted in it in a direction indicated by an arrow.

As shown in FIG. 11B, the receiving optical transmission device has a lead frame 101, a light-receiving element 103 and an amplifier electric circuit element 104 which are mounted on the lead frame 101, a resin section 105 sealing the light-receiving element 102 and the amplifier electric circuit element 104, and a case 109 covering the resin section 105.

The light-receiving element 103 and the amplifier electric circuit element 104 are each die-bonded in a predetermined island position of the lead frame 101 with conductive adhesive material such as Ag paste, and electrodes on the light-receiving element 103 and the amplifier electric circuit element 104 are electrically connected to electrodes formed on the lead frame 101 by bonding with wires 106 such as Au wires.

The resin section 105 is made of, for example, optically permeable thermosetting epoxy resin and is molded by a transfer molding method or the like. A lens 105b is provided on one side of the resin section 105 to increase the efficiency of optical coupling with an optical fiber a. Furthermore, the case 109 is made of light-blocking resin or metallic material, and holds an optical fiber which has been inserted in it in a direction indicated by an arrow.

The optical fiber a has a diameter of the order of 2 mm, and the optical transmission device has a size of at least the order of a few mm or more and is not so small as to be accommodated in small electronic equipment.

Furthermore, as shown in FIGS. 11A and 11B, unidirectional transmission is usually performed and the transmitting optical transmission device and the receiving optical transmission device are independent of each other, so that even if the transmitting optical transmission device and the receiving optical transmission device are arranged to be used for bidirectional transmission, transmitted light does not become stray light to affect its own receiving device.

However, in recent years, photoelectric signal transmission devices particularly used for portable equipment have been aimed at being small, short, and surface-mounted and have needed bidirectional communication.

For this reason, conventionally, there has been a bidirectional optical transmission device which has a laser diode (LD) silicon substrate on which a bare chip LD and a LD optical fiber are mounted, a photodiode (PD) silicon substrate on which a bare chip PD and a PD optical fiber are mounted, and a light-blocking and conductive metal plate sandwiched between the LD silicon substrate and the PD silicon substrate (see J2001-291923A)

However, the conventional bidirectional optical transmission device has a problem that the thickness and size of it increases because the three layers of the LD silicon substrate, the PD silicon substrate, and the metal plate are stacked. The conventional bidirectional optical transmission device also has a problem that the number of parts of it increases due to the metal plate additionally needed.

### SUMMARY OF THE INVENTION

It is therefore an object of the present invention to provide a bidirectional optical transmission device which is small and prevents leakage of light (stray light) from a light-emitting element to a light-receiving element.

A bidirectional optical transmission device according to the present invention comprises:

a base material;

a light-emitting element and a light-receiving element which are mounted on one side of the base material;

an optically permeable resin section sealing the light-emitting element and the light-receiving element; and

a light-blocking receptacle covering the resin section,

wherein the resin section includes a light emitting side resin section sealing the light-emitting element and a light receiving side resin section sealing the light-receiving element, with a slit being provided between the light emitting side resin section and the light receiving side resin section; and

wherein the receptacle has a claw disposed in the slit of the resin section.

In the bidirectional optical transmission device of this invention, due to the presence of the claw of the receptacle in the slit between the light emitting side resin section and the light receiving side resin section, leakage of light (stray light) from the light-emitting element is prevented between the light-emitting element and the light-receiving element without increasing the thickness and number of parts of the device.

Thus, the device can be reduced in size and is able to prevent leakage of light from the light-emitting element to the light-receiving element, thereby becoming particularly suitable for use in portable equipment.

In one embodiment, the slit has a length equal to a distance between opposite sides of the resin section and a depth enough to divide the resin section, and the light emitting side resin section and the light receiving side resin section are spaced from and not in contact with each other.

In this embodiment, leakage of light from the light-emitting element to the light-receiving element is prevented more securely due to the light emitting side resin section and the light receiving side resin section being spaced from and in non-contact with each other.

In one embodiment, the light emitting side resin section and the light receiving side resin section are connected with each other by the base material.

In this embodiment, the work of assembling the bidirectional optical transmission device becomes easy due to the light emitting side resin section and the light receiving side resin section being connected with each other by the base material.

In one embodiment, the slit is formed generally in a V-shape in section.

In this embodiment, the slit formed generally in a V-shape ensures the mold releasability of the resin section and facilitates the alignment of the claw of the receptacle.

In one embodiment, the base material is a lead frame, which has, in a position corresponding to the slit, a part of a length spanning the distance between the opposite sides of the resin section.

In the bidirectional optical transmission device of this embodiment, the lead frame is not previous to light and prevents leakage of light from the light-emitting element more securely between the light-emitting element and the light-receiving element due to the part of the lead frame, present in a position corresponding to the slit, formed in the length spanning the distance between the opposite sides of the resin section.

In one embodiment, the base material is a substrate which has, in the position corresponding to the slit, a metal wiring barrier formed in the length spanning the distance between the opposite sides of the resin section.

In this embodiment, the barrier, which has the length spanning the distance between the opposite sides of the resin section, prevents light from passing through the substrate. Thus, leakage of light from the light-emitting element is prevented more securely between the light-emitting element and the light-receiving element.

In one embodiment, the base material is a substrate which has a through-hole in a position corresponding to the slit.

According to this embodiment, the through-hole prevents light from entering and traveling in the substrate. Thus, leakage of light from the light-emitting element is prevented more securely between the light-emitting element and the light-receiving element.

In one embodiment, the base material is a multilayer substrate including a barrier metal layer which is exposed to the slit in a position corresponding to the slit.

In this embodiment, the barrier metal layer exposed to the slit in the position corresponding to the slit prevents light from entering the substrate. Thus, leakage of light from the light-emitting element is prevented more securely between the light-emitting element and the light-receiving element.

In one embodiment, the base material is a substrate on which a light-blocking resist is provided so as to cover the substrate from the underside of the light-emitting element to the underside of the light-receiving element via a position corresponding to the slit.

In this embodiment, the light-blocking resist, which covers the substrate from the underside of the light-emitting element to the underside of the light-receiving element via the position corresponding to the slit, prevents light from entering the substrate. Thus, leakage of light from the light-emitting element is prevented more securely between the light-emitting element and the light-receiving element.

In one embodiment, the light emitting side resin section and the light receiving side resin section are formed of a same material.

According to this embodiment, the device can be easily manufactured because the light emitting side resin section and the light receiving side resin section can be molded at the same time.

In one embodiment, the resin section is provided, on one side thereof, with a light emitting side lens for the light emitting side resin section and a light receiving side lens for the light receiving side resin section.

According to this embodiment, the optical coupling with optical fibers is improved due to the light emitting side lens and the light receiving side lens which are provided on one side of the resin section.

In one embodiment, the bidirectional optical transmission device further comprises a transmitting optical fiber placed facing the light-emitting element, and a receiving optical fiber placed facing the light-receiving element. And, the transmitting optical fiber and the receiving optical fiber each have a diameter of 0.6 mm, and a gap between the transmitting optical fiber and the receiving optical fiber is 1 mm or less.

According to this embodiment, the bidirectional optical transmission device can be reduced in size due to the transmitting optical fiber and the receiving optical fiber each having a diameter of 0.6 mm and the gap between the transmitting optical fiber and the receiving optical fiber of 1 mm or less. The value of “0.6 mm” for the diameter of the optical fiber is intended herein to be construed as covering a range including a tolerance of ±50 μm

In one embodiment, a light-blocking member is provided on at least one of a surface facing the slit of the light emitting side resin section or a surface facing the slit of the light receiving side resin section.

According to this embodiment, in the inspection of the device conducted before a molded assembly including the light-emitting and light-receiving elements, the base material, and the resin section is placed in the receptacle, measurements free from leakage of light from the light-emitting element between the light-emitting element and the light-receiving element are achievable due to the light-blocking member provided on the side facing the slit of the light emitting side resin section and/or the side facing the slit of the light receiving side resin section.

### BRIEF DESCRIPTION OF THE DRAWINGS

The present invention will become more fully understood from the detailed description given hereinbelow and the accompanying-drawings which are given byway of illustration only, and thus are not intended to limit the present invention, and wherein:

FIG. 1A shows a schematic configuration of a first embodiment of the bidirectional optical transmission device according to the present invention in a state in which a receptacle is omitted;

FIG. 1E shows a schematic configuration of the first embodiment of the bidirectional optical transmission device according to the present invention in a state in which optical fibers are provided;

FIG. 2A shows a schematic configuration of a second embodiment of the bidirectional optical transmission device according to the present invention in a state in which a receptacle is omitted;

FIG. 2B shows a schematic configuration of the second embodiment of the bidirectional optical transmission device according to the present invention in a state in which optical fibers are provided;

FIG. 3A shows a schematic configuration of a third embodiment of the bidirectional optical transmission device according to the present invention in a state in which a receptacle is omitted;

FIG. 3B shows a schematic configuration of the third embodiment of the bidirectional optical transmission device according to the present invention in a state in which optical fibers are provided;

FIG. 4A shows a schematic configuration of a fourth embodiment of the bidirectional optical transmission device according to the present invention in a state in which a receptacle is omitted;

FIG. 4B is a schematic plan view of the fourth embodiment of the bidirectional optical transmission device according to the present invention in a state in which the receptacle is omitted;

FIG. 4C shows a schematic configuration of the fourth embodiment of the bidirectional optical transmission device according to the present invention in a state in which optical fibers are provided;

FIG. 5A shows a schematic configuration of a fifth embodiment of the bidirectional optical transmission device according to the present invention in a state in which a receptacle is omitted;

FIG. 5B shows a schematic configuration of the fifth embodiment of the bidirectional-optical transmission device according to the present invention in a state in which optical fibers are provided;

FIG. 6A shows a schematic configuration of a sixth embodiment of the bidirectional optical transmission device according to the present invention in a state in which a receptacle is omitted;

FIG. 6B shows a schematic configuration of the sixth embodiment of the bidirectional optical transmission device according to the present invention in a state in which optical fibers are provided;

FIG. 7A shows a schematic configuration of a seventh embodiment of the bidirectional optical transmission device according to the present invention in a state in which a receptacle is omitted;

FIG. 7B shows a schematic configuration of the seventh embodiment of the bidirectional optical transmission device according to the present invention in a state in which optical fibers are provided;

FIG. 8A shows a schematic configuration of an eighth embodiment of the bidirectional optical transmission device according to the present invention in a state in which a receptacle is omitted;

FIG. 8B shows a schematic configuration of the eighth embodiment of the bidirectional optical transmission device according to the present invention in a state in which optical fibers are provided;

FIG. 9 shows a schematic configuration of a bidirectional optical transmission device as a comparative example;

FIG. 10 shows a schematic configuration of a bidirectional optical transmission device as a comparative example;

FIG. 11A shows a schematic configuration of a transmitting optical transmission device according to background art; and

FIG. 11B shows a schematic configuration of a receiving optical transmission device according to background art.

### DETAILED DESCRIPTION OF THE INVENTION

The present invention will be described in detail below with reference to embodiments shown in the figures.

### First Embodiment

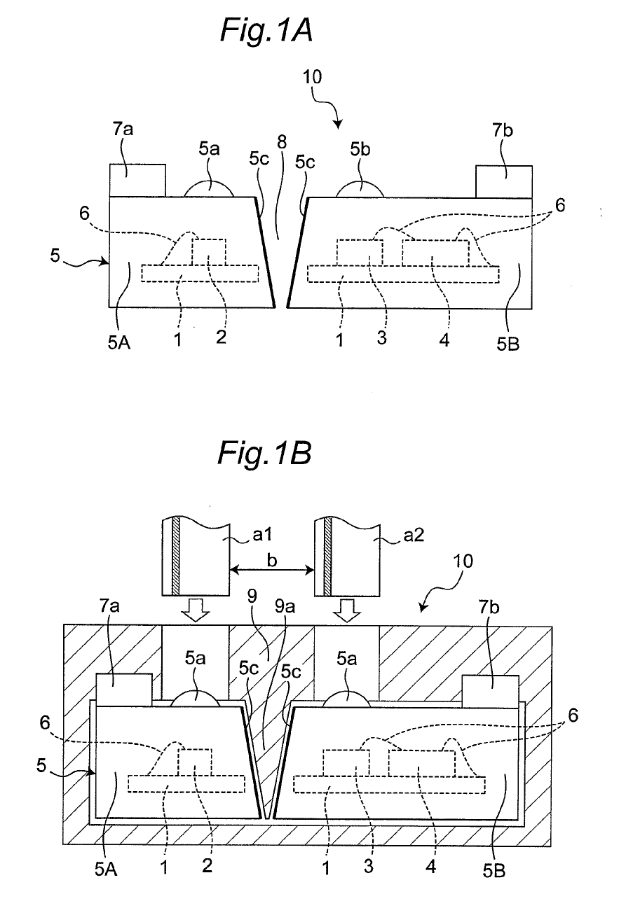

FIGS. 1A and 1B show a schematic configuration of a first embodiment of the bidirectional optical transmission device according to the present invention. FIG. 1A shows a state of the bidirectional optical-transmission device in which a receptacle is omitted, and FIG. 1B shows a state of the bidirectional optical transmission device in which optical fibers are provided.

As shown in FIGS. 1A and 1B, the bidirectional optical transmission device 10 of this invention has a lead frame 1 as a base material. Alight-emitting element 2, a light-receiving element 3, and an amplifier electric circuit element 4 are mounted on one side of the lead frame 1. The light-emitting element 2, the light-receiving element 3, and the amplifier electric circuit element 4 are sealed with an optically permeable resin section 5. The resin section 5 is contained in a light-blocking receptacle 9.

The light-emitting element 2, the light-receiving element 3, and the amplifier electric circuit element 4 are each die-bonded in a predetermined island position of the lead frame 1 with conductive adhesive material such as Ag paste.

Electrodes on the light-emitting element 2, the light-receiving element 3, and the amplifier electric circuit element 4 are electrically connected with electrodes formed on the lead frame 1 by bonding with wires 6 such as Au wires.

The resin section 5 is made of, for example, an optically permeable thermosetting epoxy resin and is molded by a transfer molding method or the like. The resin section 5 includes a light emitting side resin section 5A sealing the light-emitting element 2, and a light receiving side resin section 5B sealing the light-receiving element 3.

A slit 8 is provided between the light emitting side resin section 5A and the light receiving side resin section 5B. The slit 8 has a length equal to the distance between opposite sides (which are sides parallel to the paper sheet of the drawing of FIG. 1A) of the resin section 5 and a depth to divide the resin section 5, and the light emitting side resin section 5A and the light receiving side resin section 5B are spaced apart from each other. The slit 8 is formed generally in a V-shape in section.

The light emitting side resin section 5A and the light receiving side resin section 5B are connected with each other by the lead frame 1. The light emitting side resin section 5A and the light receiving side resin section 5B have been molded at the same time by a transfer molding method or the like.

The resin section 5 is provided, on one side thereof, with a light emitting side lens 5a for the light emitting side resin section 5A and a light receiving side lens 5b for the light receiving side resin section 5B. Furthermore, protrusions 7a and 7b for aligning and fixing the resin section 5 to the receptacle 9 are provided on one side of the resin section 5.

The receptacle 9 has a claw 9a disposed in the slit 8 of the resin section 5. The claw 9a is formed generally in a V-shape in section, which shape corresponds to the shape of the slit 8.

A transmitting optical fiber a1 is inserted in the receptacle 9 in a direction indicated by an arrow and is fixed to the receptacle 9 so as to face the light-emitting element 2, while a receiving optical fiber a2 is inserted in the receptacle 9 in a direction indicated by an arrow and is fixed to the receptacle 9 so as to face the light-receiving element 3.

The transmitting optical fiber a1 and the receiving optical fiber a2 each have a diameter of 0.6 mm, and the gap b between the transmitting optical fiber a1 and the receiving optical fiber a2 is 1 mm or less, but more than 0 mm. For the optical fibers a1 and a2, optical fibers of other diameters, such as, 0.4 mm, 0.75 mm, 1.0 mm, maybe applicable. This holds true with the other embodiments described below.

A light-blocking member 5c is provided on both of a surface facing the slit 8 of the light emitting side resin section 5A and a surface facing the slit 8 of the light receiving side resin section 5B. The light-blocking member 5c is made of a resin or by plating.

According to the bidirectional optical transmission device configured as described above, the claw 9a of the receptacle 9 is disposed in the slit 8 between the light emitting side resin section, 5A and the light receiving side resin section 5B, so that leakage of light (stray light) from the light-emitting element 2 is prevented between the light-emitting element 2 and the light-receiving element 3 without increasing the thickness and number of parts of the device.

Thus, the device can be reduced in size and is able to prevent leakage of light from the light-emitting element 2 to the light-receiving element 3, thereby becoming particularly suitable for use in portable equipment.

Furthermore, according to the bidirectional optical transmission device configured as described above, the light emitting side resin section 5A and the light receiving side resin section 5B are spaced apart from each other, namely in a non-contact manner with each other, so that leakage of light from the light-emitting element 2 can be prevented more securely between the light-emitting element 2 and the light-receiving element 3.

Furthermore, according to the bidirectional optical transmission device configured as described above, the light emitting side resin section 5A and the light receiving side resin section 5B are connected with each other by the lead frame 1, so that the work of assembling the bidirectional optical transmission device becomes easy.

Furthermore, according to the bidirectional optical transmission device configured as described above, the slit 8 is formed generally in a V-shape, which assures the mold releasability of the resin section 5 and alignment of the claw 9a of the receptacle 9.

Furthermore, according to the bidirectional optical transmission device configured as described above, the light emitting side resin section 5A and the light receiving side resin section 5B are molded at the same time, so that the device can be easily manufactured.

Furthermore, according to the bidirectional optical transmission device configured as described above, the light emitting side lens 5a and the light receiving side lens 5b are provided on one side of the resin section, 50 that good optical coupling between the optical fibers a1 and a2 and light-emitting and light-receiving elements 22 and 23 is achieved.

Furthermore, according to the bidirectional optical transmission device configured as described above, the transmitting optical fiber a1 and the receiving optical fiber a2 each have a diameter of 0.6 mm and the gap b between the transmitting optical fiber a1 and the receiving optical fiber a2 is 1 mm or less, so that the bidirectional optical transmission device can be reduced in size.

Furthermore, according to the bidirectional optical transmission device configured as described above, a light-blocking member 5c is provided on at least one of the side surface facing the slit 8 of the light emitting side resin section 5A and the side surface facing the slit 8 of the light receiving side resin section 5B so that a measurement free from leakage of light from the light-emitting element 2 between the light-emitting element 2 and the light-receiving element 3 becomes possible in the inspection of the device conducted before a molded assembly including the light-emitting and light-receiving elements 2 and 3, the lead frame 1, the resin section 5, etc. is placed in the receptacle 9.

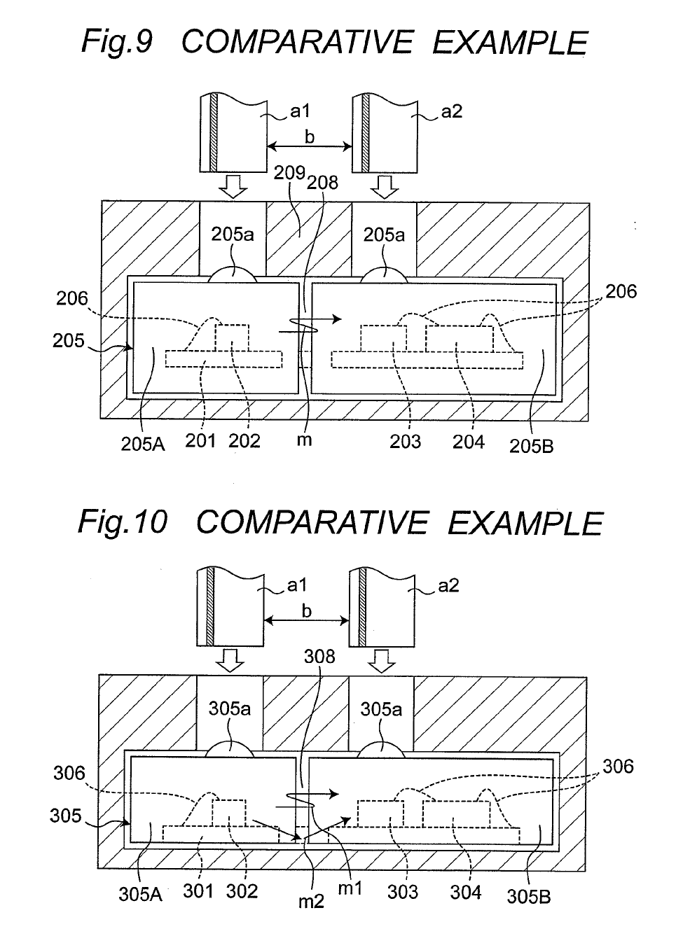

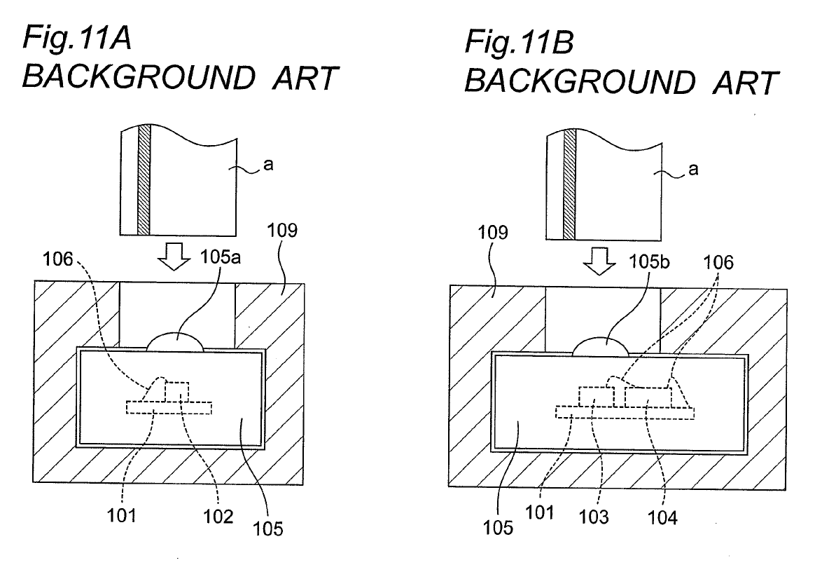

Next, FIG. 9 schematically shows the configuration of a bidirectional optical transmission device as a comparative example. As shown in FIG. 9, a light-emitting element 202, a light-receiving element 203, and an amplifier electric circuit element 204 are mounted on a lead frame 201 and are sealed with a resin section 205. The resin section 205 is housed in a light-blocking receptacle 209.

The light-emitting element 202, the light-receiving element 203, and the amplifier electric circuit element 204 are each die-bonded in a predetermined island position of the lead frame 201 with conductive adhesive material such as Ag paste.

Electrodes on the light-emitting element 202, the light-receiving element 203, and the amplifier electric circuit element 204 are electrically connected with electrodes formed on the lead frame 201 by bonding with wires 6 such as Au wires.

The resin section 205 is made of, for example, optically permeable thermosetting epoxy resin and is molded by a transfer molding method or the like. A light emitting side lens 205a and a light receiving side lens 205b are provided on one side of the resin section 205 in order to increase the efficiencies of optical coupling with optical fibers a1 and a2, respectively. The optical fibers a1 and a2 each have a diameter of 0.6 mm, and the gap b between the optical fibers a1 and a2 is 1 mm or less.

The resin section 205 includes a light emitting side resin section 205A and a light receiving side resin section 205B. A slit 208 is provided between the light-emitting element 202 and the light-receiving element 203, and aims to prevent leakage of light (stray light) from the light-emitting element 202 to the light-receiving element 203.

However, only the slit 208 is insufficient to prevent leakage of light (stray light), and there is apprehension that light leaks beyond the slit 208 as indicated by an arrow m.

### Second Embodiment

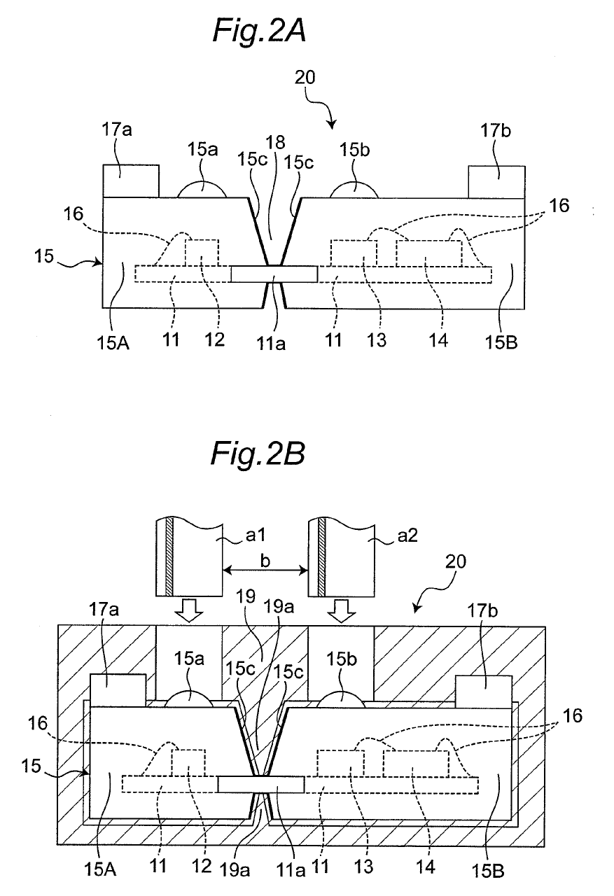

FIGS. 2A and 2B show a second embodiment of the bidirectional optical transmission device according to the present invention. The second embodiment is different from the first embodiment in the shape of the lead frame.

In other words, in the bidirectional optical transmission device 20 of the second embodiment, the lead frame 11 is formed in a length spanning the distance between the opposite sides (which are parallel to the paper sheet of FIG. 2A) of the resin section 15 in a position corresponding to the slit 18. Part 11a of the lead frame 11 divides the slit 18 into two of the upper and lower parts. Claws 19a of the receptacle 19 are disposed in the upper part and the lower part of the slit 18, respectively.

Except for the above structure, the lead frame 11, light-emitting element 12, light-receiving element 13, amplifier electric circuit element 14, resin section 15, light emitting side resin section 15A, light receiving side resin section 15B, light emitting side lens 15a, light receiving side lens 15B, light-blocking members 15c, wires 16, protrusions 17a and 17b, slit 18, receptacle 19 and claws 19a of the second embodiment have structures similar to those of the lead frame 1, light-emitting element 2, light-receiving element 3, amplifier electric circuit element 4, resin section 5, light emitting side resin section 5A, light receiving side resin section 5B, light emitting side lens 5a, light receiving side lens 5b, light-blocking members 5c, wires 6, protrusions 7a and 7b, slit 8, receptacle 9 and claw 9a of the first embodiment.

According to the bidirectional optical transmission device configured as described above, the lead frame 11 has a part that is formed in the length spanning the distance between the opposite sides of the resin section 15 in a position corresponding to the slit 18, so that the lead frame 11 is not previous to light and prevents leakage of light from the light-emitting element 12 more securely between the light-emitting element 12 and the light-receiving element 13.

### Third Embodiment

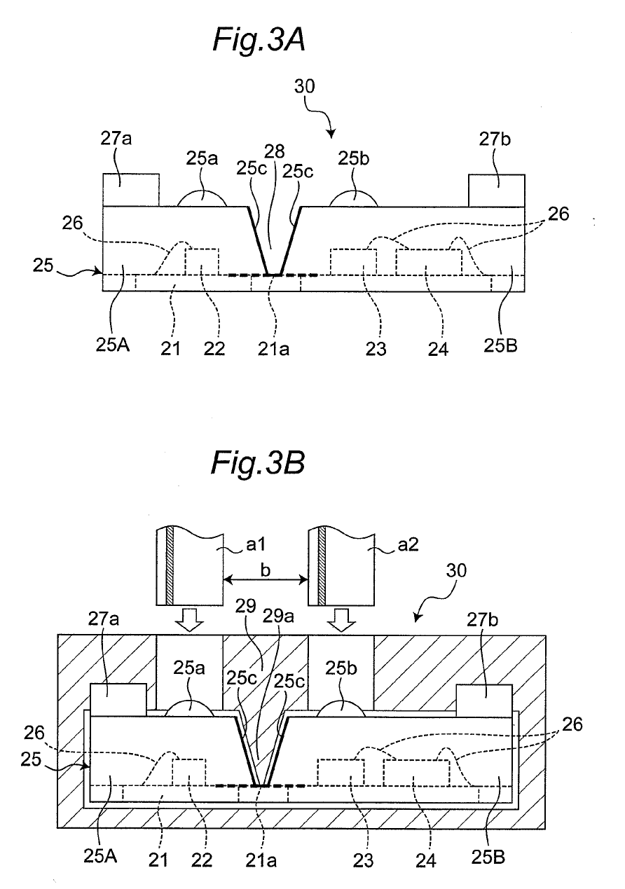

FIGS. 3A and 3B show a third embodiment of the bidirectional optical transmission device according to the present invention. The third embodiment is different from the first embodiment in that a lead frame is not used but a substrate is used as a base material.

In other words, in the bidirectional optical transmission device 30 of the third embodiment, a substrate 21 (of glass epoxy or the like) is used as a base material. The substrate 21 connects spaced-apart light emitting side resin section 25A and light receiving side resin section 25B with each other.

The substrate 21 has a metal wiring barrier 21a which is formed in a length spanning the distance between the opposite sides of a resin section 25 in a position corresponding to a slit 28. The barrier 21a is a flat metal wiring left on the substrate 21 between a light-emitting element 22 and a light-receiving element 23.

Except for the above structure, the light-emitting element 22, light-receiving element 23, amplifier electric circuit element 24, resin section 25, light emitting side resin section 25A, light receiving side resin section 25B, light emitting side lens 25a, light receiving side lens 25B, light-blocking members 25c, wires 26, protrusions 27a and 27b, slit 28, receptacle 29 and claw 29a of the third embodiment have structures similar to those of the light-emitting element 2, light-receiving element 3, amplifier electric circuit element 4, resin section 5, light emitting side resin section 5A, light receiving side resin section 5B, light emitting side lens 5a, light receiving side lens 5b, light-blocking members 5c, wires 6, protrusions 7a and 7b, slit 8, receptacle 9 and claw 9a of the first embodiment.

According to the bidirectional optical transmission device configured as described above, the substrate 21 has the barrier 21a which is formed in the length spanning the distance between the opposite sides of the resin section 25 in a position corresponding to the slit 18, so that the barrier 21a prevents light from entering the substrate 21, so that leakage of light from the light-emitting element 22 is prevented more securely between the light-emitting element 22 and the light-receiving element 23.

Next, FIG. 10 schematically shows the configuration of a bidirectional optical transmission device as a comparative example. As shown in FIG. 10, a light-emitting element 302, a light-receiving element 303, and an amplifier electric circuit element 304 are mounted on a substrate 301 and are sealed with a resin section 305. The resin section 305 is covered with a light-blocking receptacle 309.

The light-emitting element 302, the light-receiving element 303, and the amplifier electric circuit element 304 are each die-bonded in a respective predetermined island position oaf the substrate 301 with conductive adhesive material such as Ag paste.

Electrodes on the light-emitting element 302, the light-receiving element 303, and the amplifier electric circuit element 304 are electrically connected with electrodes formed on the substrate 301 by bonding with wires 306 such as Au wires.

The resin section 305 is made of, for example, an optically permeable thermosetting epoxy resin and is formed by a transfer molding method or the like. A light emitting side lens 305a and a light receiving side lens 305b are provided on one side of the resin section 305 in order to increase the efficiencies of optical coupling with optical fibers a1 and a2, respectively. The optical fibers a1 and a2 each have a diameter of 0.6 mm, and the gap b between the optical fibers a1 and a2 is 1 mm or less.

The resin section 305 includes a light emitting side resin section 305A and a light receiving side resin section 305B. A slit 308 is provided between the light-emitting element 302 and the light-receiving element 303, and aims to prevent leakage of light (stray light) from the light-emitting element 302 to the light-receiving element 303.

However, only the slit 308 is insufficient to prevent leakage of light (stray light), and there is apprehension that light leaks beyond the slit 308 as indicated by an arrow m1 and that light leaks through the substrate 301 as indicated by an arrow m2.

### Fourth Embodiment

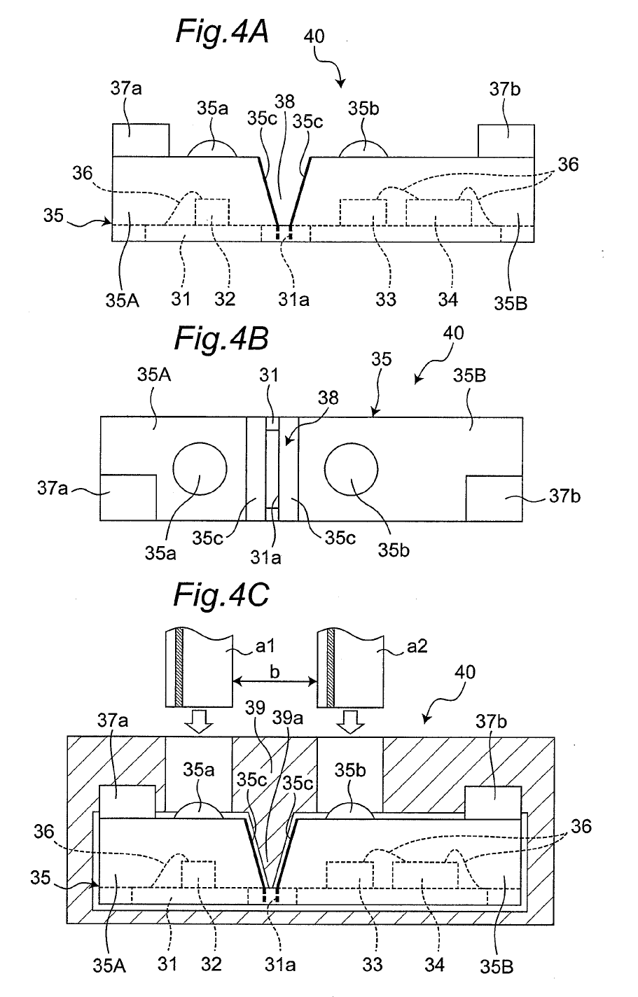

FIGS. 4A, 4B, and 4C show the fourth embodiment of a bidirectional optical transmission device according to the present invention. The fourth embodiment is different from the third embodiment in the shape of the substrate.

In other words, in the bidirectional optical transmission device 40 of the fourth embodiment, a substrate 31 has a through-hole 31a in a position corresponding to a slit 38. The through-hole 31a communicates with the slit 38, and is formed in the shape of a rectangle, which is long in a direction perpendicular to the direction of a straight line connecting the light-emitting element 32 with the light-receiving element 33, in a plan view as shown in FIG. 4B.

Except for the above structure, the substrate 31, light-emitting element 32, light-receiving element 33, amplifier electric circuit element 34, resin section 35, light emitting side resin section 35.A, light receiving side resin section 35B, light emitting side lens 35a, light receiving side lens 35B, light-blocking members 35c, wires 36, protrusions 37a and 37b, slit 38, receptacle 39 and claw 39a of the fourth embodiment have structures similar to those of the substrate 21, light-emitting element 22, light-receiving element 23, amplifier electric circuit element 24, resin section 25, light emitting side resin section 25A, light receiving side resin section 25B, light emitting side lens 25a, light receiving side lens 25b, light-blocking members 25c, wires 26, protrusions 27a and 27b, slit 28, receptacle 29 and claw 29a of the third embodiment.

According to the bidirectional optical transmission device configured as described above, the substrate 31 has a through-hole 31a in a position corresponding to the slit 38, so that the through-hole 31a prevents light from entering and traveling in the substrate 31, so that leakage of light from the light-emitting element 32 is prevented more securely between the light-emitting element 32 and the light-receiving element 33.

### Fifth Embodiment

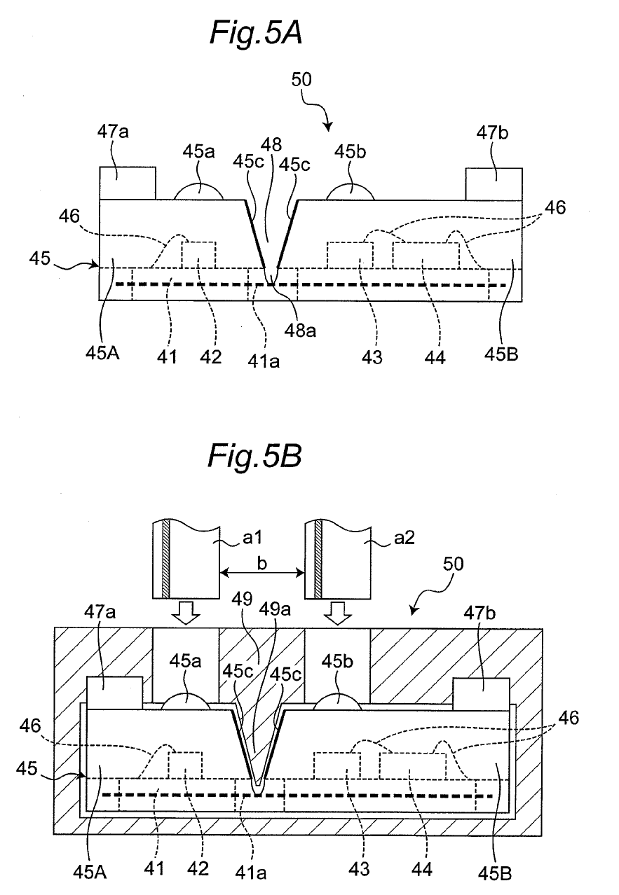

FIGS. 5A and 5B show a fifth embodiment of the bidirectional optical transmission device according to the present invention. The fifth embodiment is different from the third embodiment in the shape of the substrate.

In other words, in the bidirectional optical transmission device 50 of the fifth embodiment, a substrate 41 is a multilayer substrate including a barrier metal layer 41a. The barrier metal layer 41a is exposed to a slit 48 in a position corresponding to the slit 48. The barrier metal layer 41a is the second top layer of the substrate 41a.

The substrate 41 is subjected to a dicing process according to the position of the slit 48 until the barrier metal layer 41a is reached to thereby form a cut section 48a in the substrate 41 and expose the barrier metal layer 41a to the slit 48. The cut section 48a may be formed before or after the substrate 41 is sealed with the resin section 45.

Except for the above structure, the substrate 41, light-emitting element 42, light-receiving element 43, amplifier electric circuit element 44, resin section 45, light emitting side resin section 45A, light receiving side resin section 45B, light emitting side lens 45a, light receiving side lens 45b, light-blocking members 45c, wires 46, protrusions 47a and 47b, slit 48, receptacle 49 and claw 49a of the fifth embodiment have structures similar to those of the substrate 21, light-emitting element 22, light-receiving element 23, amplifier electric circuit element 24, resin section 25, light emitting side resin section 25A, light receiving side resin section 25B, light emitting side lens 25a, light receiving side lens 25b, light-blocking members 25c, wires 26, protrusions 27a and 27b, slit 28, receptacle 29 and claw 29a of the third embodiment.

According to the bidirectional optical transmission device configured as described above, the barrier metal layer 41a of the substrate 41 is exposed to the slit 48 in a position corresponding to the slit 48, so that the barrier metal layer 41a does not allow light to pass through the substrate 41 and prevents leakage of light from the light-emitting element 42 more securely between the light-emitting element 42 and the light-receiving element 43.

### Sixth Embodiment

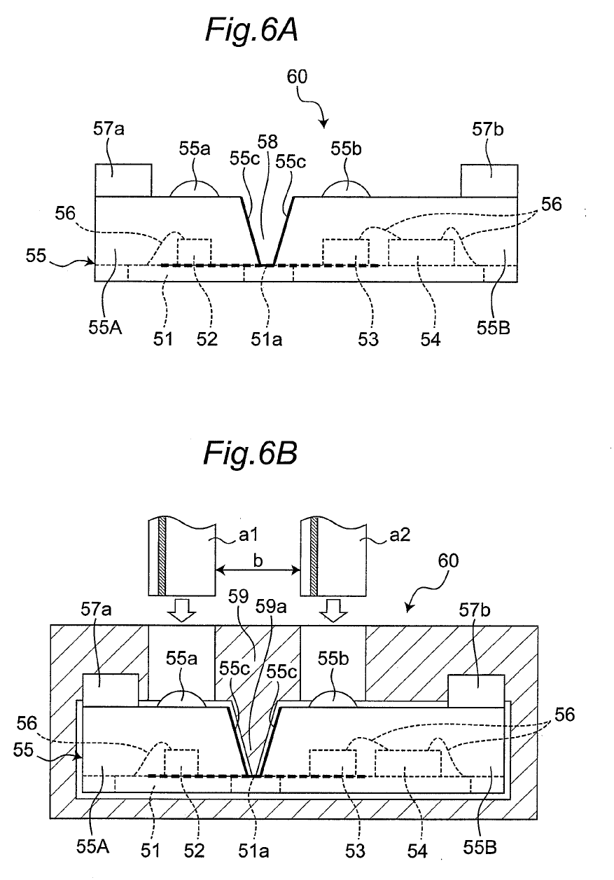

FIGS. 6A and 6B show a sixth embodiment of the bidirectional optical transmission device according to the present invention. The sixth embodiment is different from the third embodiment in the shape of the substrate.

In other words, in the bidirectional optical transmission device 60 of the sixth embodiment, a light-blocking resist 51a is provided on a substrate 51 so as to cover the substrate 51 from the underside of a light-emitting element 52 to the underside of a light-receiving element 53 via a position corresponding to a slit 58. The material of the light-blocking resist 51a is, for example, a material selectively blocking light of a wavelength for transmission of the light-emitting element 52. The substrate 51 has no barrier 21a of the third embodiment.

Except for the above structure, the substrate 51, light-emitting element 52, light-receiving element 53, amplifier electric circuit element 54, resin section 55, light emitting side resin section 55A, light receiving side resin section 55B, light emitting side lens 55a, light receiving side lens 55b, light-blocking members 55c, wires 56, protrusions 57a and 57b, slit 58, receptacle 59 and claw 59a of the sixth embodiment have structures similar to those of the substrate 21, light-emitting element 22, light-receiving element 23, amplifier electric circuit element 24, resin section 25, light emitting side resin section 25A, light receiving side resin section 25B, light emitting side lens 25a, light receiving side lens 25b, light-blocking members 25c, wires 26, protrusions 27a and 27b, slit 28, receptacle 29 and claw 29a of the third embodiment.

According to the bidirectional optical transmission device configured as described above, the light-blocking resist 51a is provided on the substrate 51 so as to cover the substrate 51 from the underside of the light-emitting element 52 to the underside of the light-receiving element 53 through a position corresponding to the slit 58, so that the light-blocking resist 51a does not allow light to enter the substrate 51 and prevents leakage of light from the light-emitting element 52 more securely between the light-emitting element 52 and the light-receiving element 53.

### Seventh Embodiment

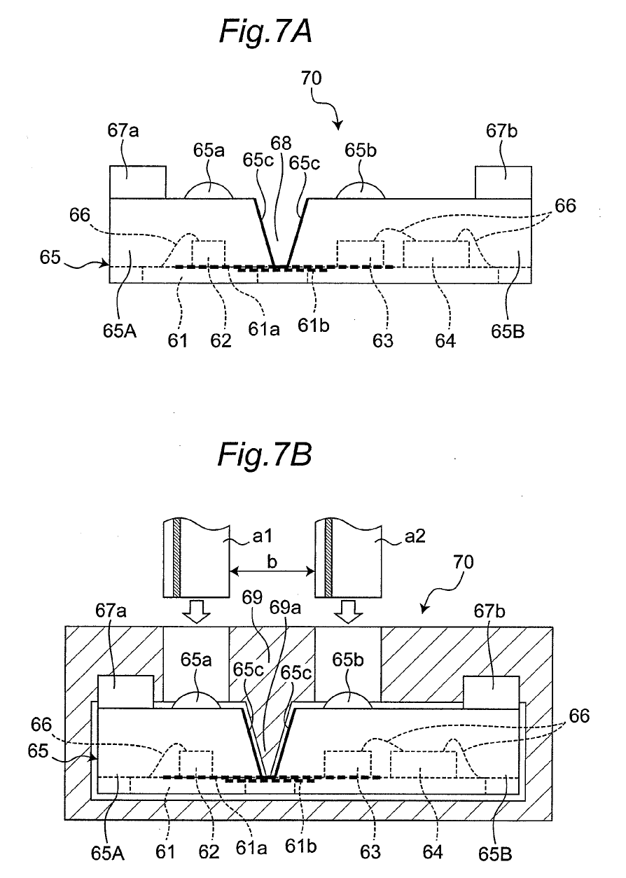

FIGS. 7A and 7B show a seventh embodiment of the bidirectional optical transmission device according to the present invention. The seventh embodiment is different from the third embodiment in the shape of the substrate.

In other words, in the bidirectional optical transmission device 70 of the seventh embodiment, a light-blocking resist 61a is provided on a substrate 61 so as to cover the substrate 61 from the underside of a light-emitting element 62 to the underside of a light-receiving element 63 through a position corresponding to a slit 68. The material of the light-blocking resist 61a is, for example, a material selectively blocking light of a wavelength for transmission of the light-emitting element 62. The light-blocking resist 61a is disposed above a barrier 61b having the same structure as that of the barrier 21a of the third embodiment.

Except for the above structure, the substrate 61, light-emitting element 62, light-receiving element 63, amplifier electric circuit element 64, resin section 65, light emitting side resin section 65A, light receiving side resin section 65B, light emitting side lens 65a, light receiving side lens 65b, light-blocking members 65c, wires 66, protrusions 67a and 67b, slit 68, receptacle 69 and claw 69a of the seventh embodiment have structures similar to those of the substrate 21, light-emitting element 22, light-receiving element 23, amplifier electric circuit element 24, resin section 25, light emitting side resin section 25A, light receiving side resin section 25B, light emitting side lens 25a, light receiving side lens 25b, light-blocking members 25c, wires 26, protrusions 27a and 27b, slit 28 receptacle 29 and claw 29a of the third embodiment.

According to the bidirectional optical transmission device configured as described above, due to the light-blocking resist 61a provided on the substrate 61 so as to cover the substrate 61 from the underside of the light-emitting element 62 to the underside of the light-receiving element 63 through the position corresponding to the slit 68, light is prevented from entering the substrate 61 so that it is possible to prevent leakage of light from the light-emitting element 62 more securely between the light-emitting element 62 and the light-receiving element 63.

### Eighth Embodiment

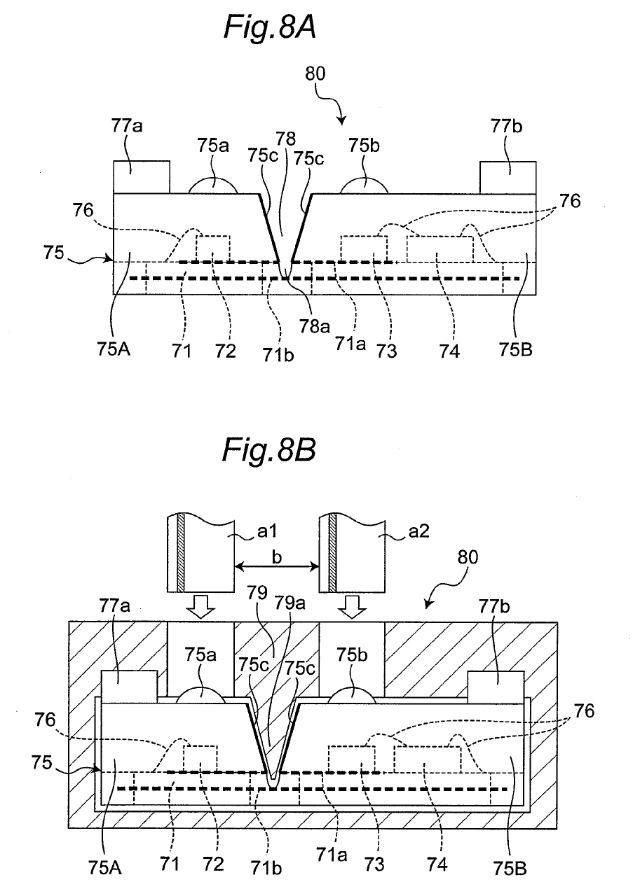

FIGS. 8A and 8B show an eighth embodiment of the bidirectional optical transmission device according to the present invention. The eighth embodiment is different from the fifth embodiment in the shape of the substrate.

In other words, in the bidirectional optical transmission device 80 of the eighth embodiment, a light-blocking resist 71a is provided on a substrate 71 so as to cover the substrate 71 from the underside of a light-emitting element 72 to the underside of a light-receiving element 73 through a position corresponding to a slit 78. The material of the light-blocking resist 71a is, for example, a material selectively blocking light of a wavelength for transmission of the light-emitting element 72. The light-blocking resist 71a is disposed in positions avoiding a cut section 78a having the same structure as that of the cut section 48a of the fifth embodiment.

Except for the above structure, the substrate 71, barrier metal layer 71b, light-emitting element 72, light-receiving element 73, amplifier electric circuit element 74, resin section 75, light emitting side resin section 75A, light receiving side resin section 75B, light emitting side lens 75a, light receiving side lens 75b, light-blocking members 75c, wires 76, protrusions 77a and 77b, slit 78, cut section 78a, receptacle 79 and claw 79a of the eighth embodiment have structures similar to those of the substrate 41, barrier metal layer 41a, light-emitting element 42, light-receiving element 43, amplifier electric circuit element 44, resin section 45, light emitting side resin section 45A, light receiving side resin section 45B, light emitting side lens 45a, light receiving side lens 45b, light-blocking members 45c, wires 46, protrusions 47a and 47b, slit 48, cut section 48a, receptacle 49 and claw 49a of the fifth embodiment.

According to the bidirectional optical transmission device configured as described above, the light-blocking resist 71a is provided on the substrate 71 so as to cover the substrate 71 from the underside of the light-emitting element 72 to the underside of the light-receiving element 73 through a position corresponding to the slit 78, so that the light-blocking resist 71a does not allow light to pass through the substrate 71 and prevents leakage of light from the light-emitting element 72 more securely between the light-emitting element 72 and the light-receiving element 73.

The present invention is not limited to the above embodiments. For example, the light-blocking member only has to be provided on at least one of one side surface facing a slit of a light emitting side resin section or one side surface facing the slit of a light receiving side resin section. Furthermore, a light-blocking resist may be provided on the whole of one side of a substrate. Furthermore, the features of the first to eighth embodiments may be combined in any way.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bidirectional optical transmission device comprising:
a base material;
a light-emitting element and a light-receiving element which are mounted on one side of the base material;
an optically permeable resin section sealing the light-emitting element and the light-receiving element; and
a light-blocking receptacle covering the resin sections,
wherein the resin section includes a light emitting side resin section sealing the light-emitting element and a light receiving side resin section sealing the light-receiving element, with a slit being provided between the light emitting side resin section and the light receiving side resin section; and
wherein the receptacle has a claw disposed in the slit of the resin section.

2. A bidirectional optical transmission device as claimed in claim 1, wherein:
the slit has a length equal to a distance between opposite sides of the resin section and a depth enough to divide the resin section; and
the light emitting side resin section and the light receiving side resin section are spaced from and not in contact with each other.

3. A bidirectional optical transmission device as claimed in claim 2, wherein the light emitting side resin section and the light receiving side resin section are connected with each other by the base material.

4. A bidirectional optical transmission device as claimed in claim 1, wherein the slit is formed generally in a V-shape in section.

5. A bidirectional optical transmission device as claimed in claim 3, wherein:
the base material is a lead frame; and
the lead frame has, in a position corresponding to the slit, a part of a length spanning the distance between the opposite sides of the resin section.

6. A bidirectional optical transmission device as claimed in claim 3, wherein the base material is a substrate which has, in a position corresponding to the slit, a metal wiring barrier formed in a length spanning the distance between the opposite sides of the resin section.

7. A bidirectional optical transmission device as claimed in claim 3, wherein the base material is a substrate which has a through-hole in a position corresponding to the slit.

8. A bidirectional optical transmission device as claimed in claim 3, wherein the base material is a multilayer substrate including a barrier metal layer which is exposed to the slit in a position corresponding to the slit.

9. A bidirectional optical transmission device as claimed in claim 3, wherein the base material is a substrate on which a light-blocking resist is provided so as to cover the substrate from the underside of the light-emitting element to the underside of the light-receiving element via a position corresponding to the slit.

10. A bidirectional optical transmission device as claimed in claim 1, wherein the light emitting side resin section and the light receiving side resin section are formed of a same material.

11. A bidirectional optical transmission device as claimed in claim 1, wherein the resin section is provided, on one side thereof, with a light emitting side lens for the light emitting side resin section and a light receiving side lens for the light receiving side resin section.

12. A bidirectional optical transmission device as claimed in claim 1, further comprising:
a transmitting optical fiber placed facing the light-emitting element; and
a receiving optical fiber placed facing the light-receiving element,
wherein the transmitting optical fiber and the receiving optical fiber each have a diameter of 0.6 mm; and
a gap between the transmitting optical fiber and the receiving optical fiber is 1 mm or less.

13. A bidirectional optical transmission device as claimed in claim 1, wherein a light-blocking member is provided on at least one of a surface facing the slit of the light emitting side resin section or a surface facing the slit of the light receiving side resin section.
